(19) United States
(12) Patent Application Publication
(10) Pub. No.: US 2006/0062881 A1
(43) Pub. Date: Mar. 23, 2006

(54) Non-bleeding and edible color film coating for seeds and the like

(76) Inventor: Denis Gustavo Berndt, Cerrillos Santiago (CL)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/946,065

(22) Filed: Sep. 22, 2004

(51) Int. Cl. A21D 10/00

(52) U.S. Cl. 426/549

(57) ABSTRACT

The invention relates to the method of making a non-bleeding and edible color film coating for seeds and the like comprising a pigment and an edible film-former polymer which acts as an effective moisture barrier preventing color bleeding. The method includes preparing a pigment suspension in alcohol, with or without the use of a protective colloid, mixing the pigment suspension with a solution of an edible film-former polymer in mixtures of water and alcohol, prepared with or without the use of a plasticizer, and applying the film coating to a seed. Additionally, the invention relates to the method of making a non-bleeding and edible color film coating for seeds and the like using a film-former pigment, without using an edible film-former polymer.

### BACKGROUND OF THE INVENTION

(1) Field of the Invention

This invention relates to the method of making a non-bleeding and edible color film coating for seeds and the like. More specifically, a non-bleeding and edible color film coating for seeds used as food ingredients.

1. Today all type of seeds are use as food ingredients in bakery, cereal mixes, snacks, desserts, icecreams, sauces, dressings and other food products.

2. Food coloring has long been used as a way to improve the appearance of food and bright colors are often use as a way to attract kids and teenagers to certain food products like confections, snacks or beverages.

3. The use of colored seeds can be use as a way to differentiate a food product and to improve its appearance. However, since most food products are exposed to high humidity environments, the color coating must be water resistant, in other words the colored seed must not bleed when eaten or in contact with high water activity products like milk or yogurt.

4. Seeds are also commonly used as decorative topping in bakery products like breads, buns and rolls. Hulled sesame seed is widely used as a topping on hamburger buns all around the world. Kids and teenagers are a big part of the target market of hamburgers sold mainly through food chains.

5. The use of colored sesame seeds as decorative topping in hamburger buns can be use as a way to attract kids and teenagers. The colored seeds can be used to form, letters, words, numbers or any other decorative figures and to give a more colorful appearance to the hamburger bun.

6. The colored seeds for decorative topping in bakery products must comply at least with the following conditions:
a) Color must not bleed from the seed
b) Color film coating must resist baking heating

7. Non-bleeding is important because the seeds will be exposed to water vapor and high water activity environments at various stages before reaching the final customer. A very undesirable effect of bleeding is the discoloration of the seed and the staining of the hamburger bun in the area surrounding the seed. Also, as for any other application, non-bleeding is important to prevent mouth staining when the seed is eaten.

8. The heat stability of the color film is important because the colored seeds will be exposed to high temperatures during baking.

(2) Description of the Related Art

1. Technology for making colored seeds is well developed since seed coloring is necessary for their correct identification. Seeds that are going to be use for seeding have been subjected to various disinfection processes and other chemical treatments. Their accidental use for foods is hence very dangerous. In view of this, seeds to be used for seeding are often colored in various hues so as to indicate clearly that they are for seeding. However, this technology uses non-water proof materials since the color layer must allowed the seed to germinate and thus is not suitable for coloring seeds that are going to be use as food ingredients, i.e. as decorative topping.

2. On the other hand, there is a well-developed technology for pharmaceutical or food film coating. However, the pharmaceutical or food film coating technology has never been use to color seed for decorative purposes, which will be exposed to adverse environmental conditions. High oven-type temperature exposure does not occur in pharmaceuticals or confections applications. Also, confections and pharmaceutical products with film coating are design to be dissolved by saliva or other body fluids. Thus, there is the need to create a method, which is uniquely suited for making a non-bleeding and edible color film coating for seeds to be use in food products.

3. The followings are some examples of the pharmaceutical or food film coating technology:
a) U.S. Pat. No. 6,468,561 disclose the coating of pharmaceutical tablets, foods, confectionery forms and the like with polydextrose, or a combination of polydextrose and another polymer, or a layer of polydextrose overcoated by a layer of another polymer. This coating process, as many other described in literature and patents, is based in water based compositions, which are not suitable to form moisture barriers as the ones needed for this application. We have tried a number of water-based coating compositions for this application and they all show poor bleeding test results. As it can be seen in table 1 and 2, water based coating pigment suspension, although coated by big amounts of film-former polymers, showed poor bleeding test results. The problem arises because there is a poor adherence of the alcohol-soluble edible film-former polymer, shellac, to the pigment particles when they have been suspended in water. This effect is probably cause by the residual water in the pigment particles. Also, there is an additional problem regarding the use of polymers like polydextrose, which are very effective in suspending the water-insoluble pigments in water.
b) U.S. Pat. No. 4,810,534 to Seabome et al. discloses a method for preparing a low water permeable, edible film containing cross-linked shellac and one or more edible sources of polyphenolics, benzaldehyde and derivatives, acetylated monoglycerides, polyglycerol esters, straight chain monocarboxylic acid and dicarboxylic acids.
c) PCT Publications WO 87/03453 and WO 86/00501 both disclose methods of preparing preformed edible films which include a layer of a hydrophilic polymer selected from the group consisting of edible, film-forming carbohydrates and proteins, and a lipid layer adhered to the hydrophilic layer.
d) U.S. Pat. No. 3,981,984 disclose the preparation of a pigment suspension for a film coating for tablets and the like comprising a solvent, pigment particles dispersed in the solvent, and a low molecular weight alcohol soluble polymer. The composition described in the patent is useful for the manufacture of a pigment suspension, however, the pigment suspension can be also manufacture with other methods, including mechanical methods. High shear stirring equipment, like Silverson mixers can maintain pigment particle suspension while they are spray over the seeds with an appropriated pumping system. Additionally the composition described in the above mentioned patent is not design for the manufacture of an effective moisture barrier, since the object of the invention is to improve the limited solubility of standard food color dyes in a coating solution for tablets. Additionally, none of the film-former polymers described in the patent, except for shellac and zein, are world wide food-approved. PVP (polyvinyl pyrrolidone) and polyethylene glycol are film-former polymers authorized only for tablets, vitamin and mineral concentrates and normutritive sweeteners. The FDA does not list PVAP (polyvinyl acetate phthalate) and CAP (cellulose acetate phthalate) as food additives permitted for direct addition to food for human consumption.

4. There are no comparative studies between shellac and zein in the related art. Both polymers are mentioned as film-former polymers for food or pharmaceutical products. However, most of the applications for film-former polymers are in the field of pharmaceutical tablets and the like. In this field, film-former polymers like PVP (polyvinyl pyrrolidone), polyethylene glycol, PVAP (polyvinyl acetate phthalate) and CAP (cellulose acetate phthalate) are used instead of shellac and zein. Many patents and other references note shellac and zein, but they are not promoted but only mentioned as known and historically used materials.

5. Here we show that shellac is the only proper film-former polymer for the manufacture of a non-bleeding and edible color film coating for seeds. It is well known in the art that shellac is an excellent film-former. However, for technical and commercial reasons its use has been declining for more than 30 years. The pharmaceutical industry have moved towards synthetic non food-grade polymers like PVP (polyvinyl pyrrolidone) and the food industry to sugar or lipid based coatings, which do not form efficient moisture barriers and thus are not suitable for this application.

6. In conclusion, the prior art does not describe any composition that is suitable for the manufacture of a non-bleeding and edible color film coating for seeds that are going to be used as food ingredients.

7. Additionally, all color coating compositions described in patents and related literature used a common basic principle: the chromophore or pigmented particles must be protected from the environment using a suitable barrier, wherein said barrier is form by a non-chromophore type of molecule. Thus, in a typical coating formula the chromophore and the barrier are two different chemical substances. There is no description in the related art of a coating composition in which the chromophore and the environmental barrier are the same molecule. By far the most preferred method for making a non-bleeding color film coating will be the method in which the chromophore will have itself the capacity of forming a suitable environmental barrier to prevent its own deterioration.

8. We investigated a number of food-grade pigments looking for this film-former capacity, and we found that solutions of some pigments have this unexpected potential. These pigments are turmeric phenolic pigments obtained from Curcuma longa. The purified powder of the turmeric contains mainly three related phenolic pigments (curcuminoids) called curcumin, dimethoxycurcumin and bisdimethoxycurcumin. These are water-insoluble, aerophyllic pigments with a surprising ability to form water-resistant, shellac-type films, suitable for film coating for pharmaceuticals tablets, confectionery products, seeds and the like.

9. The use of an edible film-former pigment simplifies considerably the coating composition and method, saving time and reducing costs.

### SUMMARY OF THE INVENTION

It is therefore an objective of the present invention to provide a non-bleeding and edible color film coating for seeds and the like.

### DETAILED DESCRIPTION OF THE INVENTION

The invention is concerned with the preparation of a colored non-bleeding and edible color film coating for seeds like sesame, poppy, sunflower, anise, pumpkin, flax, caraway, hemp, cardamon, celery, coriander, cumin, fennel, dill, fenugreek, almonds, nuts, peanuts, pistachios, walnuts, soynuts, pecan, macadamia, cashew and other edible seeds.

The invention is also concerned with the use of the above colored seeds as food ingredients in bakery, dairy, meat or confectionery products, cereal mixes, snacks, desserts, icecreams, cheese, soups, pasta, sauces, dressings, food bars, pet foods, and other food products.

The invention is also concerned with the use of the above colored seeds as decorative topping in bakery products like breads, buns and rolls. As colored decorative topping the seeds can be use to form any sort of decorative figures, such as company logo, numbers, letters, words, etc. The colored seeds can be applied at the same stage of the bread manufacture process when normal seeds, i.e. hulled sesame seeds, are applied. Any kind of molds can be use to form the decorative figures.

In accordance with the invention, the process for the manufacture of a composition for coating seeds and the like comprises the steps of:
a. preparing a pigment suspension by dissolving the protective colloid in the solvent and then mixing the opacifier and the pigments with the protective colloid solution; and
b. preparing an edible film-former polymer solution by dissolving shellac in mixtures of water and organic solvent under constant agitation and then mixing the plasticizer with the shellac solution; and
c. mixing the pigment suspension and the edible film-former polymer solution

Also, in accordance with the invention, the method for coating seeds comprises spraying the above composition over the seeds in a range of about 10% to about 20% by weight of the seeds, preferably about 15% by weight of the seeds, and then drying the coated seeds using heated air.

In accordance with the invention, the non-bleeding and edible color film coating composition comprises:

a) An edible pigment like:
FD&C synthetic lakes, iron oxides, titanium dioxide and water-insoluble natural colors like turmeric powder, cannine lake, vegetable carbon, etc.
Water-soluble pigments like FD&C synthetic dyes and water-soluble natural colors like turmeric emulsions, annatto, cochineal extract, anthocyanins, copper complexes of chlorophyllin, caramel, carthamus, betalains, gardenia, monascus, etc. which have been insolubilized by any chemical or physical methods such as precipitation, complexation, absorption, etc.
Oil-soluble chlorophyll or carotenoid or xanthophyll pigments like annatto, beta-carotene, lutein, paprika, lycopene, astaxanthin, canthaxanthin, apo-ester carotenoids, etc. used as oil suspension or as water dispersible pigments.

As it can be seen in table 1 and 2, water-soluble colorants like carminic acid (cochineal extract), although coated by big amounts of film-former polymers, showed poor bleeding test results. Thus, chromophores used for this application must be water insoluble.

Optionally an opacifier like titanium dioxide, magnesium carbonate, talc and silica gel can be use along with any of the above chromophores. Titanium dioxide is by far the most widely used opacifier. The high refractive index and bright white color of titanium dioxide make it an effective opacifier for color coatings. The preferred opacifier range, expressed as % by weight of the pigmented particles, is of about 5% to about 25%. The opacifiers can also be used to obtain white colored seeds, as they are also water insoluble white pigments.

The pigments and opacifiers can be applied individually or pigment blends can be made to achieve a desired color hue. All pigments and dyes can be obtained from Biocolor Chile S.A.

The preferred pigment particles (including the opacifier) concentration range, expressed as % by weight of the coated seeds, is of about 0.3% to about 2.2%. Below 0.3% the color is not enough to obtain an attractive product. Over 2.2% the color does not improve and costs are increased unnecessarily. Also, adding too much pigment particles will also increase the bleeding. The most preferred pigment particles concentration range being 0.8% to 1.5% depending on the pigment used.

b) A protective colloid: The use of the protective colloid is not essential since the pigment can be maintain in suspension with the use of stirring equipment, like high shear Silverson mixers. However, a protective colloid reduces the viscosity of the pigment suspension facilitating the manufacture of concentrated pigment particle suspensions and therefore reducing seed coating time and solvent consumption. Protective colloids like hydroxypropyl cellulose, ethyl cellulose or other low molecular weight alcohol soluble polymers can be used for the manufacture of the pigment suspension. Hydroxypropyl cellulose is sold by Hercules, Inc. under its trademark Klucel and ethyl cellulose is sold by Dow Chemical under its trademark Ethocel. The protective colloid can be use in a range, expressed as % by weight of the pigment particles, of 2% to 7%. The preferred range being 4% to 5% and the most preferred being 4.5%.

c) An edible film-former polymer being Shellac: Shellac refers to all forms of purified lac, a natural resin secreted by the Lac insect on certain trees, principally in India and Thailand. It has been known for three thousand years and it first became commercially important for the purple-red dye extracted from the insect to dye textiles. There are two processes for the manufacture of shellac, one based on melting (heat process) and the other, on solvent extraction (solvent process). Even though most of the red lac dye is removed during the process, some shade of orange persists. When dissolved in alcohol, “orange shellac” forms and amber-colored solution and the dried film has a distinctive amber cast. For many applications, however, a colorless film is preferred. To meet this market preference, a chemical bleaching process removes the color. Also, during this process the natural wax present in orange shellac is eliminated, resulting in what is called “dewaxed and bleached shellac”. In accordance with the invention, the shellac for coating seeds must be dewaxed and bleached. Dewaxed and bleached shellac is sold by Tolaram Overseas Corporation. Shellac must be applied in a range of 20% to 60% by weight of the pigment particles. Below 20% the moisture barrier is not strong enough to prevent bleeding when highly pigmented seeds are going to be manufactured. Over 60% results are not improved and costs are increased unnecessarily. The most preferred range being 45%. As it can be seen in table 1 and 2, shellac showed excellent bleeding test results. Also, shellac coated seeds are able to resist baking which is essential for this application. For this reason shellac is the most preferred edible film-former polymer. Another edible film-former and food-approved polymer that can be used is zein, which is a maize-derived protein with the unique capacity to form films. Zein has been successfully used for coating confectionery products for decades. However, zein showed poor bleeding test results when used for coating seeds (see table 1 and table 2 for bleeding test results) and thus it is not a proper edible film-former polymer for our application.

d) A plasticizer: any food-grade plasticizing agent or mixtures thereof, may be used which is soluble in the solvent used in preparing the film-forming solution. Plasticizing agents found to be useful in film-forming solutions include propylene glycol, glycerin, diesters of phthalic acid, i.e., diethyl phthalate, acetylated monoglycerides and triacetin. The plasticizer helps extending the film shelf life and gives a more polish appearance. The plasticizer can be use in a range of about 55% to about 80% by weight of the edible film-former polymer (shellac). We have found that the optimum amount is 66%. Over 80% the coating is difficult to dry and the bleeding is substantially increased.

e) All the solids described above are dissolved in alcohol or mixtures of water and alcohol in a way that the percentage of solids in the final mixture are in a range of about 5% to about 20%. With less than 5% there is an unnecessarily waist of solvent increasing the manufacturing costs. Dispersions over 20% solids are very difficult to prepare and handle. The optimum percentage of solids is 13%.

Additionally, in accordance with the invention, the process for the manufacture of a composition for coating seeds and the like comprises solubilizing the turmeric phenolic pigments obtained from Curcuma longa in a mixture of solvent and plasticizer. Also, in accordance with the invention, the method for coating seeds comprises spraying the above composition over the seeds in a range of about 10% to about 20% by weight of the seeds, preferably about 15% by weight of the seeds, and then drying the coated seeds using heated air.

In accordance with the invention, the non-bleeding and edible color film coating comprises:

a) An edible film-former pigment. Turmeric phenolic pigments (curcumin, dimethoxycurcumin and bisdimethoxycurcumin) have the surprising ability to form water-resistant, shellac-type films, suitable for film coating for pharmaceuticals tablets, confectionery products, seeds and the like. Turmeric can be use as the pure extract (95% curcumin), which is supply by Biocolor Chile S.A. In order to form water-resistant, shellac-type films, turmeric phenolic pigments must be solubilized. Dispersions of these pigments do not form efficient moisture barriers and must be coated by shellac. The turmeric powder 95% can be use in a range of 0.5% to 1.5% by weight of the edible film-former pigment solution. The most preferred range being 1.1%. These values are a consequence of the solubility of the turmeric powder 95% in alcohol at room temperature, which is below 1.5%. Using dilute turmeric solutions, i.e., less than 0.5% will increase unnecessarily the amount of solvent used increasing the manufacturing costs. Using saturated solutions, i.e., more than 1.5%, creates the risk that some of the pigment will not be solubilized and a low quality film will be form. Using a 1.1% solution optimizes the use of solvent and assures the all phenolic pigments are solubilized.

b) A plasticizer, in general, any non-toxic, food-grade plasticizing agent, or mixtures thereof, may be used which is soluble in the solvent used in preparing the film-forming solution. Plasticizing agents found to be useful in film-forming solutions include propylene glycol, glycerin, diesters of phthalic acid, i.e., diethyl phthalate, acetylated monoglycerides and triacetin. The plasticizer helps extending the film shelf life and gives a more polish appearance. The plasticizer can be use in a range of about 50% to about 120% by weight of the edible film-former pigment (95% curcumin). We have found that the optimum amount is 90%. Over 120% the coating is difficult to dry and the bleeding is substantially increased.

The most preferred process for the manufacture of the colored non-bleeding and edible seed is using edible film-former pigments. However, the only food-approved pigments, which are capable of forming water-resistant, shellac-type films are the phenolic pigments found in Turmeric. Carotenoids can be solubilized in alcohol but they do not form an appropriated film type barrier and shellac must be used to prevent color bleeding from the seed.

TABLE 1
Coating compositions for bleeding test

| N^{o} | Pigment Suspension/Solution (1) | Film-Former Polymer (2) |
|---|---|---|
| 1 | FD&C Blue No. 1 Lake in ethanol | Shellac 14% |
| 2 | FD&C Blue No. 1 Lake in ethanol | Shellac 45% |
| 3 | FD&C Blue No. 1 Lake in ethanol | Shellac 68% |
| 4 | FD&C Blue No. 1 Lake in ethanol | Zein 45% |
| 5 | FD&C Blue No. 1 Lake in ethanol | Zein 68% |
| 6 | FD&C Blue No. 1 Lake in ethanol | Zein 200% |
| 7 | FD&C Blue No. 1 Lake in water (3) | Shellac 200% |
| 8 | Turmeric powder 95% solution in ethanol | — |
| 9 | Carminic Acid 90% solution in ethanol (4) | Shellac 1000% |
| 10 | FD&C Blue No. 1 Lake in ethanol (5) | Shellac 45% |

(1) FD&C Blue No. 1 Lake, Turmeric powder 95% and Carminic Acid 90% were used at 1.1%, 0.17% and 1.0% by weight of the coated seeds respectively
(2) by weight of pigment particles
(3) the water suspension was made using polydextrose
(4) Carminic acid is a water soluble colorant extracted from Cochineal insect
(5) Coated seeds were placed over hamburger bun dough and baked at 180° C. for 20 minutes

TABLE 2
Bleeding test results for colored coated sesame seeds
The following are the comparative results for color bleeding using the
coating compositions described in table 1 (1):

| N^{o} | 1 hour | 2 hours | 4 hours | 8 hours |
|---|---|---|---|---|
| 1 | 0.94 | 1.27 | 1.66 | 1.98 |
| 2 | 0.27 | 0.43 | 0.45 | 0.47 |
| 3 | 0.28 | 0.40 | 0.43 | 0.46 |
| 4 | 5.80 | 6.78 | 7.13 | 7.30 |
| 5 | 5.19 | 5.99 | 6.53 | 6.87 |
| 6 | 3.04 | 4.73 | 5.60 | 6.17 |
| 7 | 3.68 | 4.22 | 4.75 | 5.12 |
| 8 | 0.02 | 0.03 | 0.03 | 0.04 |
| 9 (2) | 2.40 | 2.41 | 2.42 | 2.42 |
| 10 (3) | 0.23 | 0.36 | 0.46 | 0.47 |
| (1) 100 grams of sesame seeds were coated with 15 grams of the coating composition. Then 5 grams of the coated seeds were poured into 100 grams of soft water at 20° C. Bleeding was measured as direct absorbance in a 1 cm square cell at 600 nm for formulations from 1 to 7, at 425 nm for formulation 8 and at 520 nm for formulation 9. | | | | |
| # The color intensity is measured using a Shimadzu UV mini 1240 spectrophotometer | | | | |

(2) For Carminic acid coated seeds, an absorbance of 2.40 means all color migrated from the seeds to the surrounding water. In other words, no color was remaining over the seeds after 1 hour in soft water
(2) Baked seeds were removed from the hamburger bun dough and tested as normal non-baked seeds

### EXAMPLES

The following examples are not intended to be limiting in any way, but demonstrate some of the preferred embodiments of the present invention.

### Example 1

I) A pigment suspension is made up according to the following formula:

| | |
|---|---|
| 77.0 gr. | Ethanol 96% |
| 20.0 gr. | FD&C Blue No. 1 Lake |
| 2.0 gr. | Titanium Dioxide (use as an opacifier) |
| 1.0 gr. | Hydroxypropyl cellulose (Klucel) |

The hydroxypropyl cellulose is dissolved in the alcohol. Then the powdered lake and titanium dioxide are stirred into the hydroxypropyl cellulose solution using a high shear Silverson mixer. The pigments are dispersed using the Silverson mixer for 10 minutes at 3500 rpm.

II) An edible film-former polymer solution is made up according to the following formula:

| | |
|---|---|
| 82.5 gr. | Ethanol 96% |
| 9.2 gr. | Water |
| 5.0 gr. | Shellac (dewaxed and bleached) |
| 3.3 gr. | Propylene glycol (used as plasticizer) |

The dewaxed and bleached shellac is dissolved in the mixture of water and ethanol at 60 to 80° C. under constant agitation. Propylene glycol is added once the shellac has been completely dissolved.

III) An edible film coating composition is made up mixing the above pigment suspension and edible film-former polymer solution according to the following formula:

| | |
|---|---|
| 33.0 gr. | Pigment suspension |
| 67.0 gr. | Film-former polymer solution |

15 gr. of the film coating is used to color 100 gr. of sesame seeds. The film coating is carefully sprayed over the seeds in a rotating stainless steel coating pan and dried using heated air.

### Example 2

I) A pigment suspension is made up according to the following formula:

| | |
|---|---|
| 87.0 gr. | Ethanol 96% |
| 10.0 gr. | Carmine Lake 57% |
| 2.0 gr. | Titanium Dioxide (use as an opacifier) |
| 1.0 gr. | Hydroxypropyl cellulose (Klucel) |

The hydroxypropyl cellulose is dissolved in the alcohol. Then the powdered lake and titanium dioxide are stirred into the hydroxypropyl cellulose solution using a high shear Silverson mixer. The pigments are dispersed using the Silverson mixer for 10 minutes at 3500 rpm.

II) An edible film-former polymer solution is made up according to the following formula:

| | |
|---|---|
| 82.5 gr. | Ethanol 96% |
| 9.2 gr. | Water |
| 5.0 gr. | Shellac (dewaxed and bleached) |
| 3.3 gr. | Propylene glycol (used as plasticizer) |

The dewaxed and bleached shellac is dissolved in the mixture of water and ethanol at 60 to 80° C. under constant agitation. Propylene glycol is added once the shellac has been completely dissolved.

III) An edible film coating composition is made up mixing the above pigment suspension and edible film-former polymer solution according to the following formula:

| | |
|---|---|
| 33.0 gr. | Pigment suspension |
| 67.0 gr. | Film-former polymer solution |

15 gr. of the film coating is used to color 100 gr. of sesame seeds. The film coating is carefully sprayed over the seeds in a rotating stainless steel coating pan and dried using heated air.

### Example 3

I) A pigment suspension is made up according to the following formula:

| | |
|---|---|
| 79.0 gr. | Ethanol 96% |
| 20.0 gr. | FD&C Yellow No. 6 Lake |
| 1.0 gr. | Hydroxypropyl cellulose (Klucel) |

The hydroxypropyl cellulose is dissolved in the alcohol. Then the powdered lake and titanium dioxide are stirred into the hydroxypropyl cellulose solution using a high shear Silverson mixer. The pigments are dispersed using the Silverson mixer for 10 minutes at 3500 rpm.

II) An edible film-former polymer solution is made up according to the following formula:

| | |
|---|---|
| 82.5 gr. | Ethanol 96% |
| 9.2 gr. | Water |
| 6.0 gr. | Shellac (Dewaxed and Bleached) |
| 3.3 gr. | Propylene glycol (used as plasticizer) |

The dewaxed and bleached shellac is dissolved in the mixture of water and ethanol at 60 to 80° C. under constant agitation. Propylene glycol is added once the shellac has been completely dissolved.

III) An edible film coating composition is made up mixing the above pigment suspension and edible film-former polymer solution according to the following formula:

| | |
|---|---|
| 33.0 gr. | Pigment suspension |
| 67.0 gr. | Film-former polymer solution |

15 gr. of the film coating is used to color 100 gr. of sesame seeds. The film coating is carefully sprayed over the seeds in a rotating stainless steel coating pan and dried using heated air.

### Example 4

A film-former pigment solution is made up according to the following formula:

| | |
|---|---|
| 97.9 gr. | Ethanol 96% |
| 1.1 gr. | Turmeric powder 95% |
| 1.0 gr. | Propylene glycol (used as plasticizer) |

The Turmeric powder is dissolved in the mixture of ethanol and propylene glycol (used as plasticizer) at 60° C. with slight agitation until the solution is totally transparent. 15 gr. of the film coating is used to color 100 gr. of sesame seeds. The film coating is carefully sprayed over the seeds in a rotating stainless steel coating pan. Coated seeds are dried in the rotating stainless steel coating pan using heated air.

Having thus described certain embodiments of the present invention, various alterations, modifications, and improvements will readily occur to those skilled in the art. Such alterations, modifications, and improvements are intended to be within the spirit and scope of the invention. Accordingly, the foregoing description is by way of example only, and not intended to be limiting.

1. A composition for coating seeds and the like comprising a pigment suspension and an edible film-former polymer solution, wherein said edible film-former polymer solution comprises shellac.

2. The composition of claims 1 wherein said pigment suspension comprises a solvent, an edible pigment selected from water insoluble pigments, water soluble pigments which have been previously insolubilized by any physical or chemical method and/or oil soluble pigments used as oil suspension or as water dispersible pigments, and optionally an opacifier, and optionally a protective colloid.

3. The composition of claim 2 wherein said opacifier is selected from titanium dioxide, magnesium carbonate, talc and silica gel, being in a range of about 5% to about 25% by weight of the pigment particles.

4. The composition of claim 1 wherein said pigments particles, including the opacifier, are in a range of about 0.3% to about 2.2% by weight of the coated seeds.

5. The composition of claim 2 wherein said pigment suspension the protective colloid is selected from hydroxypropyl cellulose or ethyl cellulose, being in a range of about 3% to about 6% by weight of the pigment particles.

6. The composition of claim 2 wherein said solvent is selected from a C1-C6 food grade alcohol, preferably ethanol.

7. The composition of claim 1 wherein said edible film-former polymer solution comprises an organic solvent, water, shellac and optionally a plasticizer.

8. The composition of claim 1 wherein said edible film-former polymer is shellac in a range of about 20% to about 60% by weight of the pigment particles.

9. The composition of claim 7 wherein said plasticizer is selected from propylene glycol, glycerin, diesters of phthalic acid, diethyl phthalate, acetylated monoglycerides and triacetin and mixtures of thereof, being in a range of about 55% to about 80% by weight of the edible film-former polymer.

10. The composition of claim 7 wherein said organic solvent is selected from a C1-C6 food grade alcohol, preferably ethanol.

11. Process for the manufacture of the composition of claim 1, which process comprises the steps of:
a. preparing a pigment suspension by dissolving the protective colloid in the solvent and then mixing the opacifier and the pigments with the protective colloid solution; and
b. preparing an edible film-former polymer solution by dissolving shellac in mixtures of water and organic solvent under constant agitation and then mixing the plasticizer with the shellac solution; and
c. mixing the pigment suspension and the edible film-former polymer solution

12. A composition for coating seeds and the like comprising a solvent, turmeric phenolic pigments obtained from Curcuma longa and optionally a plasticizer.

13. A composition for coating seeds of claim 12 wherein said plasticizer is selected from propylene glycol, glycerin, diesters of phthalic acid, diethyl phthalate, acetylated monoglycerides and triacetin and/or mixtures of thereof, being in a range of about 50% to about 120% by weight of the edible film-former pigment.

14. A composition for coating seeds of claim 12 wherein said solvent is selected from a food grade alcohol, preferably C1-C6, most preferred ethanol.

15. Process for the manufacture of the composition of claim 12 which process comprises solubilizing the turmeric phenolic pigments obtained from Curcuma longa in a mixture of solvent and plasticizer.

16. Method for coating seeds comprising spraying the composition of claim 1 over the seeds, and then drying the said coated seeds using heated air.

17. Method for coating seeds of claim 16 wherein said composition is useful in a range of about 10% to about 20% by weight of the seeds, preferably about 15% by weight of the seeds.

18. Coated seeds and the like wherein the seed is selected from sesame, poppy, sunflower, anise, pumpkin flax, caraway, hemp, cardamon, celery, coriander, cumin, fennel, dill, fenugreek, almonds, nuts, peanuts, pistachios, walnuts, soynuts, pecan, macadamia, cashew and other edible seeds, and the coating is the composition of claim 1.

19. Use of the coated seed of claim 18 for preparing bakery, dairy, meat or confectionery products, cereal mixes, snacks, desserts, ice creams, cheese, soups, pasta, sauces, dressings, food bars, pet foods and other food products.

20. Bakery, dairy, meat or confectionery products, cereal mixes, snacks, desserts, ice creams, cheese, soups, pasta, sauces, dressings, food bars, pet foods, and other food products comprising the coated seed of claim 18.

21. Bread, bun or roll comprising the coated seed of the claim 18.
